(19) United States
(12) Patent Application Publication
(10) Pub. No.: US 2014/0281147 A1
(43) Pub. Date: Sep. 18, 2014

(54) MEMORY SYSTEM

(71) Applicant: Kabushiki Kaisha Toshiba, Minato-ku (JP)

(72) Inventor: Noritsugu Yoshimura, Fuchu-shi (JP)

(73) Assignee: Kabushiki Kaisha Toshiba, Minato-ku (JP)

(21) Appl. No.: 13/903,098

(22) Filed: May 28, 2013

Related U.S. Application Data
(60) Provisional application No. 61/779,063, filed on Mar. 13, 2013.

(51) Int. Cl. G06F 12/02

(52) U.S. Cl. CPC G06F 12/0246
USPC 711/103

(57) ABSTRACT

According to one embodiment, a memory system includes a first interface unit configured to operate in parallel nonvolatile memories, and a second interface unit configured to receive data requested by a host from the first interface unit and transfer the data to the host independently of an order of commands sent from the host. The second interface unit includes a first storage unit configured to store commands sent from the host, a second storage unit configured to store items of first information sent from the first interface unit, and a control unit configured to perform data transfer concerning the command stored in the first storage unit in an order in which the items of first information are stored in the second storage unit.

### CROSS-REFERENCE TO RELATED APPLICATIONS

This application claims the benefit of U.S. Provisional Application No. 61/779,063, filed Mar. 13, 2013, the entire contents of which are incorporated herein by reference.

### FIELD

Embodiments described herein relate generally to a memory system.

### BACKGROUND

A NAND flash memory is known as a kind of nonvolatile semiconductor memory device. Also known is a storage device (for example, an SSD) including a NAND flash memory.

To increase the speed of the storage device, NAND memory chips serving as recording media corresponding to a plurality of channels are mounted, and the plurality of channels are operated in parallel. Concerning sequential read, however, when issuing read commands to the NAND memory chips of the plurality of channels, the order of preparing data is not maintained because the channels have different load times. For this reason, it is necessary to include a read buffer that has a sufficient storage capacity for ordering and stores the read data of each channel for ordering. In addition, since data in a range where the order is not guaranteed cannot be transferred to the host, the data transfer rate decreases (the performance of the storage device degrades) because of ordering.

### BRIEF DESCRIPTION OF THE DRAWINGS

FIG. 1 is a block diagram of a memory system according to the first embodiment;

FIG. 2 is a schematic view of a host interface controller according to the first embodiment;

FIG. 3 is a circuit diagram showing an example of a command FIFO unit;

FIG. 4 is a flowchart showing the operation of the host interface controller;

FIG. 5 is a timing chart showing the operation of the host interface controller;

FIG. 6 is a schematic view of a host interface controller according to the second embodiment;

FIG. 7 is a flowchart showing the command completion determination operation of the host interface controller;

FIG. 8 is a schematic view showing an example of a bitmap table;

FIG. 9 is a schematic view of a host interface controller according to the third embodiment;

FIG. 10 is a view showing an example of an address list stored in an address list FIFO unit;

FIG. 11 is a flowchart showing the data transfer operation of the host interface controller;

FIG. 12 is a sequence chart showing an example of the data transfer operation of the host interface controller;

FIG. 13 is a perspective view showing an example of a personal computer including the memory system;

FIG. 14 is a block diagram showing an example of the system arrangement of the personal computer including the memory system; and

FIG. 15 is a schematic view showing a server including the memory system.

### DETAILED DESCRIPTION

In general, according to one embodiment, a memory system comprising:

nonvolatile memories;

a first interface unit connected to the nonvolatile memories and configured to operate in parallel the nonvolatile memories; and

a second interface unit configured to receive data requested by a host from the first interface unit and transfer the data to the host independently of an order of commands sent from the host,

the second interface unit comprising:

a first storage unit configured to store commands sent from the host;

a second storage unit configured to store items of first information sent from the first interface unit and capable of identifying the commands; and

a control unit configured to perform data transfer concerning the command stored in the first storage unit in an order in which the items of first information are stored in the second storage unit.

The embodiments of the present invention will now be described with reference to the accompanying drawings. Note that in the following explanation, the same reference numbers denote elements having the same functions and arrangements, and a repeated explanation will be given only if necessary.

### First Embodiment

### 1. Arrangement of Memory System

A memory system includes a nonvolatile semiconductor memory. The nonvolatile semiconductor memory is a non-transitory memory whose data is not lost even after power off. In this embodiment, a NAND flash memory will be exemplified as the nonvolatile semiconductor memory. As the memory system, a solid-state drive (SSD) will be described as an example of a storage device including the NAND flash memory.

FIG. 1 is a block diagram of a memory system (storage device) 10. The memory system 10 includes a storage controller 11, a plurality of NAND flash memories (NAND memories, NAND memory chips) 12, and a random access memory (RAM) 13.

The storage controller 11 includes a processor (control unit) 14, a host interface controller (host I/F controller) 15, a NAND controller (NAND I/F controller) 16, and a RAM controller 17. The processing units are connected to each other via a bus 18. The processor 14 is a central processing unit (CPU) that generally controls the elements in the storage controller 11.

The host interface controller 15 is connected to a host device 20 via an interface 19. The host device 20 is an external device that writes or reads data to or from the memory system 10, and is formed from a single device such as a personal computer, a CPU core, or a server connected to a network, or a combination thereof.

As the interface 19, an interface capable of out-of-order execution is used. An example of the interface is a Peripheral Component Interconnect Express (PCIe) interface. Out-of-order execution indicates changing the order of commands sent from the host and performing transfer processing sequentially from data ready for data output (independently of the order of commands). On the other hand, in-order execution indicates performing data transfer processing in an order designated by commands sent from the host.

The NAND controller 16 is connected to the plurality of NAND flash memories 12 and executes data transfer processing with respect to the NAND flash memories 12. FIG. 1 illustrates four NAND flash memories 12-0 to 12-3 as an example. NAND flash memories 12-0 to 12-3 are connected to the NAND controller 16 via channels Ch0 to Ch3, respectively. The NAND controller 16 operates channels Ch0 to Ch3 (NAND flash memories 12-0 to 12-3) in parallel and executes a write operation, read operation, and erase operation. Each of channels Ch0 to Ch3 is formed from a data bus.

Each NAND flash memory 12 is a memory device capable of nonvolatilely storing data, and is used as a storage unit to store user data, programs, internal data of the memory system, and the like. More specifically, the NAND flash memory 12 stores data designated on the side of the host device 20, or stores management information to manage data storage positions in the NAND flash memory 12 or data such as firmware programs to be nonvolatilely saved. The NAND flash memory 12 includes a memory cell array in which a plurality of memory cells are arranged in a matrix. The memory cell array is formed by arranging a plurality of physical blocks as the units of erase. In the NAND flash memory 12, write and read are performed on a physical page basis. Each physical page is formed from a plurality of memory cells. Each physical block (memory block, data block) is formed from a plurality of physical pages.

The RAM controller 17 is connected to the RAM 13 and executes data transfer processing with respect to the RAM 13. The RAM 13 is used as a data transfer cache between the host device 20 and the NAND flash memories 12 and a storage unit such as a working area memory for temporary storage. The temporary storage is a state incapable of holding data after, for example, power off. Data stored in the RAM 13 include a management table expanded (read) from the NAND flash memory 12 at the time of activation (power-on) or the like and various kinds of tables created by the processor 14 at the time of data transfer processing. As the RAM 13, a dynamic RAM (DRAM) is mainly used. Alternatively, a static RAM (SRAM), a ferroelectric RAM (FeRAM), a magnetoresistive RAM (MRAM), a phase-change RAM (PRAM), or the like is also usable.

The storage controller 11 having the above-described arrangement has the functions of processing a command with respect to the host device 20, performing data transfer between the NAND flash memories 12 and the host device 20, and managing each block in the NAND flash memories 12. The memory system 10 is used as the external memory, for example, the secondary memory device (SSD) of the host device 20, and has the functions of storing data requested by the host device 20 to write and reading data requested by the host device 20 to read and outputting the data to the host device 20.

FIG. 2 is a schematic view of the host interface controller 15. The host interface controller 15 includes an intermediate FIFO (AFIFO) unit 30, a transmission FIFO (TxFIFO) unit 31, a command FIFO (CMD FIFO) unit 32, a comparator 33, a reservation exchange table 34 a current exchange table 35, a read response FIFO unit 36, a transfer control unit 37, and a selector 38. As can be understood from FIG. 2, no read buffer or the like exists between the host interface controller 15 and the NAND controller 16 to buffer read data.

At the time of data transfer (read), data (sector) and command information (CMD Info) corresponding to the sector are input from the NAND controller 16 to the host interface controller 15. The sector is the minimum unit of access from the host. The NAND controller 16 includes NAND interfaces (NAND I/Fs) and error checking and correcting (ECC) circuits corresponding to, for example, channels Ch0 to Ch3, respectively. At the time of a write, the ECC circuit generates an error correction code for write data, adds the error correction code to the write data, and sends it to the NAND flash memory. At the time of a read, the ECC circuit detects and corrects an error in read data using an error correction code included in the read data.

CMD Info includes a logical address (logical block address [LBA]), a tag, and an error flag. The tag is information used to identify a command sent from the host device 20 and individually added to each command sent from the host device 20 to the NAND controller 16. The error flag is error information of a sector and is generated by the ECC circuit.

The AFIFO unit 30 is an intermediate buffer for read processing and is formed from a first-in first-out (FIFO) buffer (storage unit). The AFIFO unit 30 temporarily stores data of each predetermined data unit (sector unit) sent from the NAND controller 16 and outputs the data to the TxFIFO unit 31 in the storage order.

The TxFIFO unit 31 is formed from a FIFO buffer (storage unit) and temporarily stores the sector sent from the AFIFO unit 30. The TxFIFO unit 31 outputs a frame generated by data conversion processing to be described later. The frame size is equal to or larger than the sector size. For example, a frame includes data in size corresponding to an integer multiple (2 or more) of a sector size.

The CMD FIFO unit 32 is formed from a FIFO buffer (storage unit), temporarily stores CMD Info sent from the NAND controller 16, and outputs it to the comparator 33 in the order of storage.

The comparator 33 searches the reservation exchange table 34 using the CMD Info sent from the CMD FIFO unit 32 and loads exchange information corresponding to the CMD Info to the current exchange table 35. The selector 38 sends the exchange information from the reservation exchange table 34 to the current exchange table 35 in accordance with an instruction from the comparator 33.

The reservation exchange table (command storage unit) 34 stores exchange information concerning a command sent from the host device 20, and also stores exchange information concerning a command to be used to perform data transfer later. The exchange information registered in the reservation exchange table 34 is the same as a command (read command) sent to the NAND controller 16 out of a plurality of commands the host device 20 has requested from the memory system 10.

Each exchange information stored in the reservation exchange table 34 includes a destination address, a sector count, a byte count, an LBA, a tag, and an error flag. The destination address is information managed on the side of the host device 20 and representing the destination (storage position) of transferred data. The sector count is the total number of sectors of data transferred by the command. The byte count is the total number of bytes of data transferred by the command.

The current exchange table (command storage unit) 35 stores exchange information used for current data transfer out of the exchange information registered in the reservation exchange table 34.

The read response FIFO unit 36 is formed from a FIFO unit (storage unit), and stores exchange information of completed data transfer out of a plurality of items of exchange information stored in the reservation exchange table 34.

Using the exchange information stored in the current exchange table 35, the transfer control unit 37 executes data transfer control concerning the command corresponding to the exchange information.

FIG. 3 is a circuit diagram showing an example of the CMD FIFO unit 32. The CMD FIFO unit 32 includes a register 40 configured to hold a tag, a register 41 configured to hold an LBA, a register 42 configured to hold a sector count, selectors SE1 to SE11, AND gates AN1 to AN3, an inverter INV, comparators CP1 and CP2, and a latch circuit LT. The CMD FIFO unit 32 includes the circuits shown in FIG. 3 numbering the same as the number of stages (entries) of the FIFO. The number of entries of the FIFO can be arbitrarily set.

Selectors SE1 to SE7 output data when the write pointer is asserted. Selectors SE8 to SE11 output data when the read pointer is asserted. The write pointer and read pointer are information used to manage an entry under processing out of the entries recorded in the CMD FIFO unit 32.

Register 40 holds a tag (TAGin) included in the CMD Info when the write pointer indicates the entry. Register 41 holds an LBA (LBAin) included in the CMD Info when the write pointer indicates the entry. Register 42 increments the sector count when the write pointer indicates the entry, and the LBA input to the LBAin continues to the immediately previously input LBA. The tag held by register 40 is output from selector SE8 to the comparator 33 (TAGout) when the read pointer indicates the entry. The LBA held by register 41 is output from selector SE9 to the comparator 33 (LBAout) when the read pointer indicates the entry.

When the CMD Info is input from the NAND controller 16 to the CMD FIFO unit 32, comparator CP1 compares the tag included in the CMD Info with the tag held by register 40 indicated by the write pointer. If the tags do not match, the write pointer is incremented through the path of AND gate AN1, the inverter INV, and AND gate AN2, and the CMD Info is registered in another entry. AND gate AN2 determines whether new CMD Info has been input (new command input condition). When new CMD Info has been input (AND gate AN2=High), load terminals L of registers 40 and 41 are asserted, and registers 40 and 41 hold the tag and LBA included in the new CMD Info, respectively.

In addition, comparator CP2 compares the LBA included in the CMD Info with the address obtained by incrementing the LBA held by register 41 indicated by the write pointer (step S1). If the LBAs are not sequential, the write pointer is incremented, and the CMD Info is registered in another entry.

On the other hand, if the LBAs are sequential (AND gate AN3=High), the sector count is incremented. AND gate AN3 determines whether a plurality of items of CMD Info including sequential LBAs have continuously been input (command continuity condition). When the sector count is zero (low in step S2), the commands are regarded as discontinuous. Even if the LBAs are sequential in the data transfer, the CMD Info is registered in another entry.

When the sector count of register 42 indicated by the read pointer≠0, the load operation from the reservation exchange table 34 to the current exchange table 35 is possible. The reservation exchange table 34 is searched using the CMD Info, and matching exchange information is loaded to the current exchange table 35, thereby completing preparation of data transfer. When the sector count is not zero (step S3), data transfer is continued. Every time sector transfer is complete, the sector count of register 42 is decremented. When the sector count is zero (step S4), the read pointer is incremented.

Entry of the command (CMD Info) to the CMD FIFO unit 32 is disabled when all the entries of the CMD FIFO unit 32 are filled. Alternatively, entry may be disabled when the sum of sector counts of all registers 42 exceeds a predetermined value.

### 2. Operation

The operation of the host interface controller 15 will be described next. FIG. 4 is a flowchart showing the operation of the host interface controller 15.

When a plurality of commands are sent from the host device 20 to the memory system 10, the processor 14 sends, out of the plurality of commands, a command (read command) to read data from NAND flash memories 12-0 to 12-3 to the host interface controller 15 and the NAND controller 16. The host interface controller 15 stores exchange information associated with the read command received from the processor 14 in the reservation exchange table 34. The NAND controller 16 reads data from NAND flash memories 12-0 to 12-3 based on the read command received from the processor 14. The data read from NAND flash memories 12-0 to 12-3 are sent to the host interface controller 15 via the NAND controller 16. The NAND controller 16 generates CMD Info corresponding to the data and sends the CMD Info to the host interface controller 15.

When the host interface controller 15 receives the data (sector) and the corresponding CMD Info sent from the NAND controller 16 (step S10), the CMD Info is stored in the CMD FIFO unit 32, and the sector is stored in the AFIFO unit 30. The comparator 33 searches the reservation exchange table 34 using the CMD Info (step S11), and loads the corresponding exchange information to the current exchange table 35 (step S12). The sector is transferred from the AFIFO unit 30 to the TxFIFO unit 31. At this point of time, preparation of data transfer to the host device 20 is complete.

Next, the transfer control unit 37 performs host command control to convert the data format in accordance with the command sent from the host device 20 (the exchange information stored in the current exchange table 35). In the host command control, the sector is converted into a frame. The transfer control unit 37 generates a frame header using the current exchange table 35 (step S13). At this time, the transfer control unit 37 calculates the destination address for the host device 20 using the destination address and LBA in the current exchange table 35 and embeds the destination address in the frame header.

In this frame header generation, first, the LBA of the sector is captured. The LBA is included in the data path through which the CMD Info concerning the sector is transferred during the transfer of the sector from the NAND controller 16 to the TxFIFO unit 31. The transfer control unit 37 captures the LBA of the data path. The transfer control unit 37 then calculates the destination address of the sector using the start destination address (first destination address) and start LBA (first LBA) included in the current exchange table 35 and the captured LBA.

Next, the transfer control unit 37 generates a frame using the frame header generated in step S13 and the plurality of sectors stored in the TxFIFO unit 31 (step S14). The transfer control unit 37 then transmits the frame to the host device 20 via the interface 19 (step S15).

Note that switching of the current exchange table 35 is performed (1) when the CMD Info sent from the NAND controller 16 indicates another tag, or (2) when the continuity of LBAs is broken. When transfer processing concerning the exchange information (command) of the current exchange table 35 is interrupted halfway, the exchange information of the current exchange table 35 is fed back to the reservation exchange table 34.

In the host command control, register 42 of the CMD FIFO unit 32 counts the number of sectors upon receiving sectors. The calculated sector count is compared with the sector count in the current exchange table 35, thereby ascertaining completion of data transfer of the command (completed command management). At the time of command completion, the exchange information stored in the reservation exchange table 34 is transferred to the read response FIFO unit 36 and deleted from the reservation exchange table 34.

FIG. 5 is a timing chart that summarizes the above-described operation. When commands (CMD Info) A0 and A1 are input from the NAND controller 16 to the host interface controller 15, sector count A is sequentially incremented. The write pointer and read pointer indicate the entry A corresponding to commands A (A0 and A1). When sector count (A)≠0, the transfer request signal is asserted, the reservation exchange table 34 is searched using command A, and corresponding exchange information is loaded to the current exchange table 35.

Next, the LBA captured from the data path is collated with the destination address and LBA in the current exchange table 35, and the destination address of the sector to be transferred is calculated. A frame header is generated using the destination address.

The data (sectors) A0 and A1 are transferred from the NAND controller 16 to the TxFIFO unit 31. Every time sector transfer is complete, the sector transfer completion signal is asserted. The sector count is thus decremented sequentially. When the sector count (A)=0, the transfer request signal is negated, and the exchange information in the current exchange table 35 is fed back to the reservation exchange table 34.

Sectors A0 and A1 are transferred from the NAND controller 16 to the TxFIFO unit 31. Next, a frame including sectors A0 and A1 and the frame header is transferred to the host device 20 via the PCIe interface 19.

After that, since the sector count (B)≠0, the transfer request signal is asserted, and data transfer concerning command B (B0, B1) is performed.

### 3. Effect

As described above in detail, according to the first embodiment, read data ordering is unnecessary in the memory system 10 including an interface (PCIe interface or the like) that permits out-of-order transfer. For this reason, the buffer for read data needed for ordering can be removed. It is therefore possible to reduce the cost and circuit scale of the memory system 10. In addition, since the overhead of processing associated with the read data ordering can be reduced, the performance concerning the read can be improved.

### Second Embodiment

The second embodiment is an embodiment of a method of easily determining completion of sector transfer. FIG. 6 is a schematic view of a host interface controller 15 according to the second embodiment.

The host interface controller 15 includes a bitmap table (table storage unit) 50. The bitmap table 50 manages, for each LBA, whether data transfer corresponding to an LBA is complete. More specifically, the bitmap table 50 stores an LBA (remaining start LBA) having the minimum address out of the LBAs yet to be transferred and information representing for each LBA whether data transfer is complete. Details of the bitmap table 50 will be described later.

FIG. 7 is a flowchart showing the command completion determination operation of the host interface controller 15. FIG. 8 is a schematic view showing an example of the bitmap table 50. Out of the symbols of the bitmap table 50 shown in FIG. 8, a circle represents transfer completion; a cross, transfer incompletion; and a bar, Null. One cell of the bitmap table 50 represents information about one sector.

An LBA is included in the data path through which CMD Info concerning a sector is transferred during transfer of the sector from a NAND controller 16 to a TxFIFO unit 31. A transfer control unit 37 captures the LBA of the data path (step S20). For example, when the NAND controller 16 outputs CMD Info, the transfer control unit 37 captures the LBA from the CMD Info.

Next, the transfer control unit 37 sets a flag at the position of an LBA whose sector has already been transferred from the NAND controller 16 to the TxFIFO unit 31 out of the bitmap table 50. More specifically, the transfer control unit 37 sets a flag at a position of “captured LBA—remaining start LBA” out of the bitmap table 50 (step S21). In the example of FIG. 8, flag=circle.

Next, the transfer control unit 37 determines whether the flag (=1) is set at the first bitmap [0] out of the bitmap table 50 (step S22). If no flag is set at the bitmap [0], steps S20 and S21 are repeated.

If the flag is set at the bitmap [0], that is, the sector of the remaining start LBA has already been transferred, the transfer control unit 37 shifts the bitmap so as to clear the flag of the current bitmap [0] and increments the remaining start LBA (step S23).

In a state (1) of the example shown in FIG. 8, for example, the remaining start LBA=0, and the bitmap [0] represents the transfer state of the remaining start LBA=0. In the state (1), sectors #1, #2, and #3 have been transferred. The sector number corresponds to the LBA number. In the state (2), sector #0 has been transferred, and the flag is set in the bitmap [0]. Four bits are thus shifted, and the remaining start LBA=4.

In the state (3), sectors #6 and #7 have been transferred, and the flag is set at corresponding positions. In the state (4), sector #4 has been transferred, and the flag is set at the bitmap [0]. One bit is thus shifted, and the remaining start LBA=5.

In the state (5), sector #5 has been transferred, and the flag is set at a corresponding position. Three bits are thus shifted, and the remaining start LBA=8.

Note that the number of entries of the bitmap depends on the number of NAND flash memories (channels) that can operate simultaneously. When a function of stopping command issuance when the number of entries of the bitmap has reached the number of channels is added to the NAND controller 16, the number of entries can be limited to the number of channels×2−1.

As described above in detail, according to the second embodiment, it is possible to confirm LBAs whose sectors have been transferred and also confirm the start LBA (remaining start LBA) having the minimum address out of the LBAs of sectors yet to be transferred by referring to the bitmap table 50. Hence, the transfer control unit 37 can easily determine a command whose data transfer to a host device 20 is complete by comparing the remaining start LBA with the LBA of a reservation exchange table 34.

### Third Embodiment

In the third embodiment, a destination address representing a data storage position on the side of a host device 20 is managed on the side of the host device 20. In this embodiment, an address list including the destination address needs to be read from the host device 20.

FIG. 9 is a schematic view of a host interface controller 15 according to the third embodiment. The host interface controller 15 includes an address list FIFO unit 51. The address list FIFO unit 51 is formed from a FIFO buffer (storage unit) and stores an address list read from the host device 20.

FIG. 10 is a view showing an example of the address list stored in the address list FIFO unit 51. The address list stores a destination address, a size (data size), a next list address, a tag, an LBA, and a byte pointer.

The next list address indicates the position of the address list next to the address list, that is, the index of the next address list. The byte pointer represents the byte position of the data of the address list in the sector.

The data transfer operation of the host interface controller 15 using the address list will be described next. FIG. 11 is a flowchart showing the data transfer operation of the host interface controller 15.

A transfer control unit 37 collates the start LBA of a current exchange table 35 with the address list stored in the address list FIFO unit 51 (step S30), and determines whether the size of data described in the address list has reached the byte count described in the start LBA of the current exchange table 35 (step S31). If NO in step S31, the address list is short. Hence, address list prefetching from the host device 20 is continued (step S32). The address list read from the host device 20 is stored in the address list FIFO unit 51.

If YES in step S31, the transfer control unit 37 determines whether data is being transferred through the path from a NAND controller 16 to a TxFIFO unit 31 (step S33). If the data is not being transferred, address list prefetching from the host device 20 is continued.

On the other hand, if the data is being transferred, the transfer control unit 37 collates the LBA captured from the data path with the address list (step S34), and determines whether the captured LBA exists in the address list (step S35). If the captured LBA does not exist in the address list, the transfer control unit 37 directly reads the address list from the host device 20 (step S36). The read address list is stored in the address list FIFO unit 51. Next, the transfer control unit 37 collates the captured LBA with the address list (step S37), and repeats the direct read of the address list until the captured LBA exists in the address list (step S38). Note that the directly read address list is overwritten at the same position of the address list FIFO unit 51. This makes it possible to prevent an increase in the storage capacity of the address list FIFO unit 51.

Upon acquiring the address list of transfer data, the transfer control unit 37 acquires the destination address from the address list, and generates a frame header using the destination address (step S39). The transfer control unit 37 transfers the frame to the host device 20 using a PCIe interface 19 (step S40).

The transfer control unit 37 then erases the address list for which the data transfer is complete from the address list FIFO unit 51 (step S41). Erase of the address list can be determined using the remaining start LBA described in a bitmap table 50. More specifically, an address list concerning an LBA before the remaining start LBA is erased. When the address list for which the data transfer is complete is sequentially erased from the address list FIFO unit 51, the number of entries of the address list FIFO unit 51 can be limited.

FIG. 12 is a sequence chart showing an example of the data transfer operation of the host interface controller 15.

First, address lists stored in the address list FIFO unit 51 are collated (list check), and address list prefetching is repeated until the start of data transfer. In the example of FIG. 12, the address lists of LBAs=0, 1, 3, 4 are read from the host device 20.

When data transfer starts, an LBA (for example, LBA=0) captured from the data path is collated with the address list, and the destination address 1000h is acquired from the address list of LBA=0. A frame header including the destination address 1000h is generated, and a frame including the frame header and sector #0 is transferred to the host device 20. The LEA=0 is collated with the bitmap table 50 (post-transfer LEA check), and the address list of LBA=0 is erased from the address list FIFO unit 51.

Next, when the LBA=10 captured from the data path does not exist in the address list, direct read of an address list is performed, and the address list of LBA=10 is read from the host device 20. After a frame including LBA=10 is transferred to the host device 20, the address list of LBA=10 is erased from the address list FIFO unit 51.

As described above in detail, according to the third embodiment, the host interface controller 15 described in the second embodiment is applicable to an arrangement example in which the host device 20 manages the destination address that is the data storage position on the side of the host device 20. In addition, implementing address list prefetching processing by hardware allows to automatically read the address list from the host device 20. This enables to reduce the burden of firmware processing.

Note that address list prefetching from the host device 20 can be performed until all entries of the address list FIFO unit 51 are filled. However, when a threshold is provided for the number of address lists capable of entry for each tag, read commands that operate in parallel in channels Ch0 to Ch3 can be efficiently transferred.

### Application Example

An example of the arrangement of the host device 20 will be described. The host device 20 can take the form of a personal computer.

FIG. 13 is a perspective view showing an example of a personal computer 200 including a memory system (SSD) 10 of the above embodiment. The personal computer 200 (for example, a notebook-type portablecomputer) includes a main body 201 and a display unit 202. The display unit 202 includes a display housing 203 and a display device 204 stored in the display housing 203.

The main body 201 includes a case 205, a keyboard 206, and a touchpad 207 serving as a pointing device. A main circuit board, an optical disk drive (ODD), a card slot, the SSD 10, and the like are stored in the case 205.

The SSD 10 may replace a conventional HDD and be included in the personal computer 200. Alternatively, the SSD 10 may be connected to an interface of the personal computer 200 and used as an additional device.

FIG. 14 is a block diagram showing an example of the system arrangement of the personal computer 200 including the SSD 10. The personal computer 200 includes a CPU 301, a north bridge 302, a main memory 303, a video controller 304, an audio controller 305, a south bridge 309, a BIOS-ROM 310, the SSD 10, an optical disk drive (ODD) unit 311, an embedded controller/keyboard controller IC (EC/KBC) 312, and a network controller 313.

The CPU 301 is a processor provided to control the operation of the personal computer 200, and executes the operating system (OS) loaded from the SSD 10 to the main memory 303. When the ODD unit 311 enables execution of at least one of read processing and write processing for a loaded optical disk, the CPU 301 executes the processing. The CPU 301 also executes the system Basic Input/Output System (BIOS) stored in the BIOS-ROM 310. Note that the system BIOS is a program for hardware control of the personal computer 200.

The north bridge 302 is a bridge device that connects the south bridge 309 and the local bus of the CPU 301. The north bridge 302 also incorporates a memory controller that controls access to the main memory 303. The north bridge 302 also has a function of executing communication with the video controller 304 and the audio controller 305 via an Accelerated Graphics Port (AGP) bus 314 and the like.

The main memory 303 temporarily stores programs and data and functions as the work area of the CPU 301. The main memory 303 is formed from, for example, a RAM.

The video controller 304 is a video reproduction controller that controls the display unit 202 used as the display monitor of the personal computer 200. The audio controller 305 is an audio reproduction controller that controls a loudspeaker 306 of the personal computer 200.

The south bridge 309 controls, for example, each device on the Low Pin Count (LPC) bus and, for example, each device on a Peripheral Component Interconnect (PCI) bus 315. The south bridge 309 controls, via the ATA interface, the SSD 10 serving as a storage device that stores various kinds of software and data. The personal computer 200 accesses the SSD 10 for each sector. A write command, a read command, a cache flash command, and the like are input to the SSD 10. The south bridge 309 also has a function of controlling access to the BIOS-ROM 310 and the ODD unit 311.

The EC/KBC 312 is a single-chip microcomputer on which an embedded controller for power management and a keyboard controller used to control the keyboard (KB) 206 and the touchpad 207 are integrated. The EC/KBC 312 has a function of powering on/off the personal computer 200 in accordance with a user operation on the power button. The network controller 313 is a communication device that executes communication with an external network such as the Internet.

The host device 20 can also be formed from a server connected to a network. FIG. 15 is a schematic view showing a server 400 including the SSD 10.

The server 400 incorporates the SSD 10 for data storage. The server 400 is connected to a network 401 (for example, the Internet). A plurality of clients 402 (personal computers) each of which provides the information and function of the server 400 are connected to the network 401 in addition to the server 400.

The server 400, for example, provides files and data stored in the SSD 10 to the clients 402 or provides the functions of its own to the clients 402.

Note that in the above-described embodiments, an SSD including NAND flash memories has been exemplified as the memory system. However, the embodiments are not limited to this and are also applicable to any other storage device such as a memory card including a NAND flash memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
nonvolatile memories;
a first interface unit connected to the nonvolatile memories and configured to operate in parallel the nonvolatile memories; and
a second interface unit configured to receive data requested by a host from the first interface unit and transfer the data to the host independently of an order of commands sent from the host,
the second interface unit comprising:
a first storage unit configured to store commands sent from the host;
a second storage unit configured to store items of first information sent from the first interface unit and capable of identifying the commands; and
a control unit configured to perform data transfer concerning the command stored in the first storage unit in an order in which the items of first information are stored in the second storage unit.

2. The system of claim 1, wherein
the first information includes a logical address and a tag used to identify the command, and
the control unit switches the command to perform data transfer when the tag indicates another command or when continuity of the logical addresses is broken.

3. The system of claim 1, further comprising:
a comparator configured to detect, from the first storage unit, a first command associated with the first information sent from the first interface unit to the second interface unit; and
a third storage unit configured to store the first command.

4. The system of claim 1, further comprising a comparator configured to detect, from the first storage unit, a first command associated with the first information sent from the first interface unit to the second interface unit,
wherein the control unit generates a header using a destination address included in the first command and transfers a frame including the header and the data to the host, the destination address indicating a data storage position on a side of the host.

5. The system of claim 4, wherein the control unit calculates the destination address using a logical address of the first information sent from the first interface unit to the second interface unit.

6. The system of claim 1, further comprising a table configured to manage a logical address and a flag indicating that data transfer of the logical address is complete,
wherein the control unit determines, using the table, a first logical address at a start of logical addresses whose data transfer is not yet complete.

7. The system of claim 6, wherein the control unit determines a command having only the logical address before the first logical address as the command whose data transfer is complete.

8. The system of claim 1, wherein the control unit reads, from the host, an address list including a logical address and a destination address indicating a data storage position on a side of the host, generates a header using the destination address, and transfers a frame including the header and the data to the host.

9. The system of claim 8, further comprising a fourth storage unit configured to store address lists,
wherein the control unit acquires the destination address from a first address list having the same logical address as the logical address of the data sent from the first interface unit to the second interface unit out of the address lists stored in the fourth storage unit.

10. The system of claim 1, further comprising a buffer configured to store the data sent from the first interface unit.

11. The system of claim 1, wherein the second storage unit comprises a FIFO buffer.

12. The system of claim 1, wherein an interface between the host and the first interface unit is capable of out-of-order execution.

13. A memory system comprising:
nonvolatile memories;
a first interface unit connected to the nonvolatile memories and configured to operate in parallel the nonvolatile memories; and
a second interface unit configured to receive data requested by a host from the first interface unit and transfer the data to the host independently of an order of commands sent from the host,
the second interface unit comprising:
a first storage unit configured to store commands sent from the host;
a second storage unit configured to store items of first information sent from the first interface unit and capable of identifying the commands, the first information including a logical address and a tag used to identify the command; and
a control unit configured to switch the command to perform data transfer when the tag indicates another command or when continuity of the logical addresses is broken.

14. The system of claim 13, wherein the control unit performs data transfer concerning the command stored in the first storage unit in an order in which the items of first information are stored in the second storage unit.

15. The system of claim 13, further comprising a comparator configured to detect, from the first storage unit, a first command associated with the first information sent from the first interface unit to the second interface unit,
wherein the control unit generates a header using a destination address included in the first command and transfers a frame including the header and the data to the host, the destination address indicating a data storage position on a side of the host.

16. The system of claim 15, wherein the control unit calculates the destination address using a logical address of the first information sent from the first interface unit to the second interface unit.

17. A memory system comprising;
nonvolatile memories;
an interface unit connected to the nonvolatile memories and configured to operate in parallel the nonvolatile memories;
a first storage unit configured to store commands sent from a host;
a second storage unit configured to store items of first information sent from the interface unit and capable of identifying the commands; and
a control unit configured to transfer data to the host in an order in which the items of first information are stored in the second storage unit.
